(19) United States
(12) Patent Application Publication
(10) Pub. No.: US 2012/0232992 A1
(43) Pub. Date: Sep. 13, 2012

(54) System and Method for Generating and Distributing Coupons

(75) Inventor: Robert R. Williamson, Columbus, MN (US)

(73) Assignee: TextEdge, Inc.

(21) Appl. No.: 13/045,130

(22) Filed: Mar. 10, 2011

(51) Int. Cl. G06Q 30/00

(52) U.S. Cl. 705/14.57

(57) ABSTRACT

A method of generating and distributing promotional offers by businesses, or on behalf of businesses to consumers, through a network, which includes collecting consumer coupon parameters regarding coupons which the consumer would be interested in and business coupon parameters regarding the terms of coupons, and matching businesses to interested consumers, and transmitting coupons to interested consumers.

### FIELD OF THE INVENTIONS

The inventions described below relate the field of coupon generation and distribution.

### BACKGROUND OF THE INVENTIONS

Current systems and methods for electronic coupon distribution rely on broadly broadcasting coupons or invitations to retrieve coupons. Some current systems use e-mail and/or text messaging to broadcast discount coupons to an indiscriminately wide consumer base. These are typical of large retail chains, and may be seen as spam. Other current systems require that consumers navigate to a website on a regular basis to view current promotions and select coupons they are interested in. Some of these systems require purchase of coupons for promotional deals, and the purchase becomes effective only when a certain number consumers commit to the purchase. Each of these coupon distribution system rely on a shotgun approach to distribution, both as to the consumer base approached and the offers provided. For example, one such site might offer coupons for exotic restaurants, laser eye surgery, and a boxing gym membership to everyone in a single county. This represents a shotgun as to coupon subject matter and a shotgun as to the consumer base. Such systems could be improved by better focusing the distribution of coupons and promotional offers.

### SUMMARY

The methods and systems described below provide for targeted distribution of coupons to consumers. The system includes an internet accessible database in which businesses can enter various parameters restricting the distribution of coupons and setting the parameters of a discount or promotional offer, and consumers can enter various parameters restricting their own acceptance of coupons and setting the parameters of discounts or promotional offers to which they are likely to be receptive and reactive. The system also includes computer processors which analyze the input from businesses and consumers, and matches the parameters input by the businesses and the input entered by the consumers to identify consumers that express interest in coupons offered by businesses, and also generates electronic coupons and transmits electronic coupons to interested consumers. The system thus accomplishes a method of collecting business coupon parameters, collecting consumer coupon parameters, identifying consumers which have expressed coupon parameters which match business coupon parameters, and transmitting coupons to those identified consumers.

The business coupon parameters include the business identity, geographic limitations for offers, the number of intended recipients of the coupon, the terms of the coupon including the discount amount, maximum discount, the duration of the offer or time period in which the offer is effective. The consumer parameters include the business identities of interest, geographic limitations of usable offers, and the time periods in which they can use offers. Other parameters that help more finely match business to consumers can be used.

Paper coupons, typically distributed by mail or by hand, refer to a form, ticket, part of a printed advertisement, etc., entitling the holder to discount on goods and services, promotional gifts or offers. Electronically distributed coupons are analogous, differing only in that they are distributed electronically, through e-mail, text messaging, and can be presented electronically or printed and presented on paper. The internet, as used herein, refers to the global computer network currently in ubiquitous use, as well as any widespread communications network for computers, smart phones or any other communications device widely used by consumers.

### BRIEF DESCRIPTION OF THE DRAWINGS

FIG. 1 illustrates an interface presented by the system to businesses, which accepts input from a business regarding the parameters of coupons to be promulgated by the system.

FIG. 2 illustrates the same view pane shown in FIG. 1, showing the manner of entry of parameters, generation of coupon text corresponding to the parameters entered by the business user.

FIG. 3 illustrates another coupon generating view pane, in which the business user can use the system to generate coupon in which the number of units subject to the discount is may be limited by the terms of the coupon.

FIG. 4 illustrates an interface presented by the system to consumers, which accepts input from consumers regarding the parameters of coupons which might be of interest to the consumer.

FIG. 5 shows a view pane which displays the history of coupons generated by the system on behalf of a business, along with the coupon parameters and the number of coupons accepted.

### DETAILED DESCRIPTION OF THE INVENTIONS

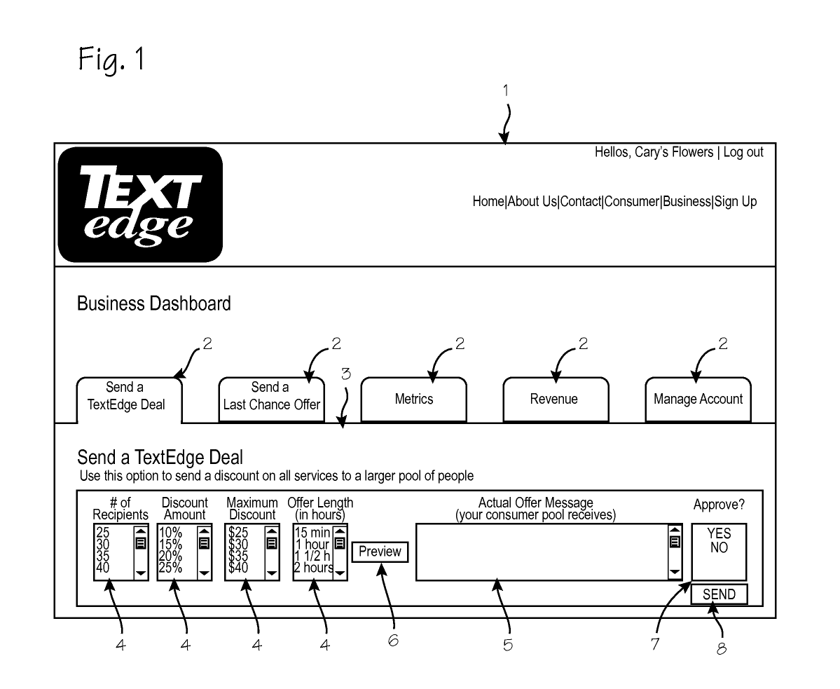

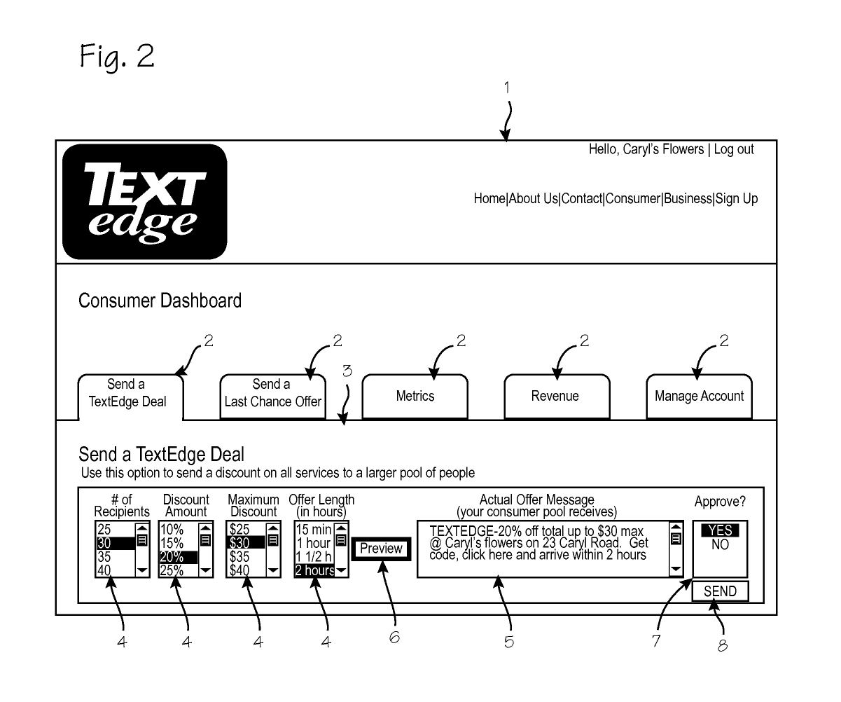

FIG. 1 illustrates an interface presented by the system to businesses, which accepts input from a business regarding the parameters of coupons to be promulgated by the system. The interface is presented in a browser window 1 in which the business dashboard is presented. The browser window includes several tabs, which allow the user to navigate to various view panes. In FIG. 1, the tabs 2 labeled “Send a TextEdge Deal,” “Send a Last Chance Offer,” “Metrics,’ “Revenue,” and “Manage Account” are displayed, and the “Send a TextEdge Message” view pane is selected by the user and thus presented by the computer which is programmed to implement the method. We will refer to this pane, labeled as item 3, as a coupon generating view pane. Prior to accessing this pane, the business user has established an account and identified its business field (restaurant, movie theater, etc.) and its location (by zip code, city name, or neighborhood) on another view pane, such as the manage account pane, or on an initial registration window. In this coupon generating view pane, the business user may use scroll down windows 4 to enter input dictating parameters of an electronic coupon, including the number of recipients to whom a coupon will be sent, the discount offered, any limitation on the total discount offered, and the duration of the offer (which may be expressed as shown, or by specifying a set time period). FIG. 2 illustrates the same view pane shown in FIG. 1, showing the manner of entry of parameters, generation of coupon text corresponding to the parameters entered by the business user. The number of recipients is limited, by selection of the business user, to 30 recipients. The discount is set to 20% and capped at $30, by selection of the business user, and the duration of the user is set at 2 hours. The computer controlling the system generates the intended text of the coupon, and displays it the text window 5. The view pane also includes a preview button 6, which, when activated by the user, will be interpreted by the computer as an instruction to display the intended text of the coupon. The approval window 7 is used to obtain a positive indication that the business user has reviewed and approved the intended text, and the send button 8 is used to instruct the computer controlling the system to send the approved message to the designated number of recipients.

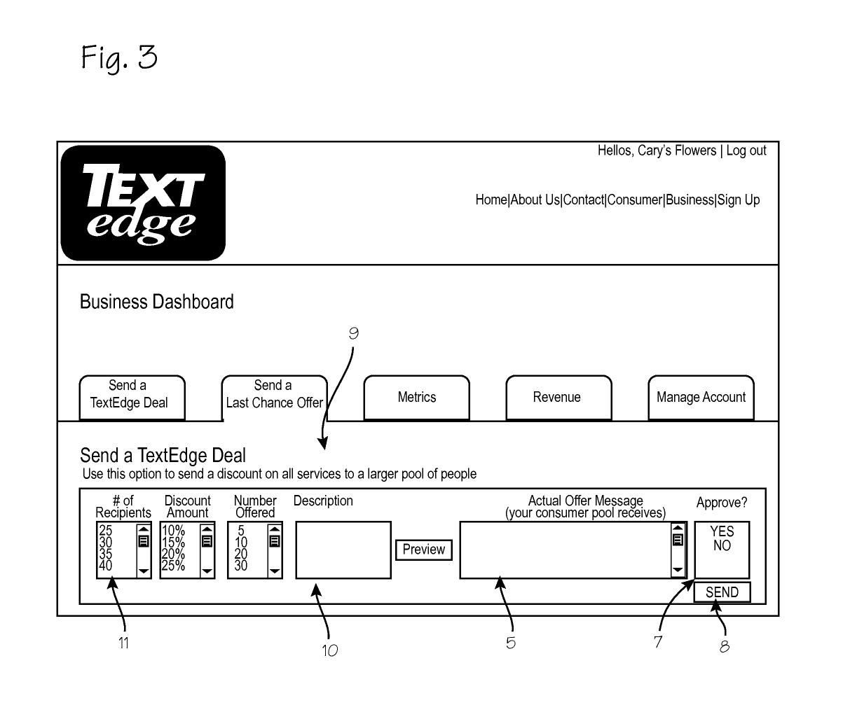

FIG. 3 illustrates another coupon generating view pane 9, in which the business user can use the system to generate coupon in which the number of units subject to the discount is may be limited by the terms of the coupon. In this coupon generating view pane, the business user can enter input dictating parameters of an electronic coupon, including the number of recipients to whom a coupon will be sent, the discount offered, and a limited number of items to be sold under the discount, and a description of those items (in the additional text entry box 10. As discussed in relation to FIG. 2, the scroll down windows are used to set the various business coupon parameters of coupons, and also includes an addition window 11 to enter text describing items subject to the discount. Because this view pane is intended to apply to a certain number of items, no duration input window is provided.

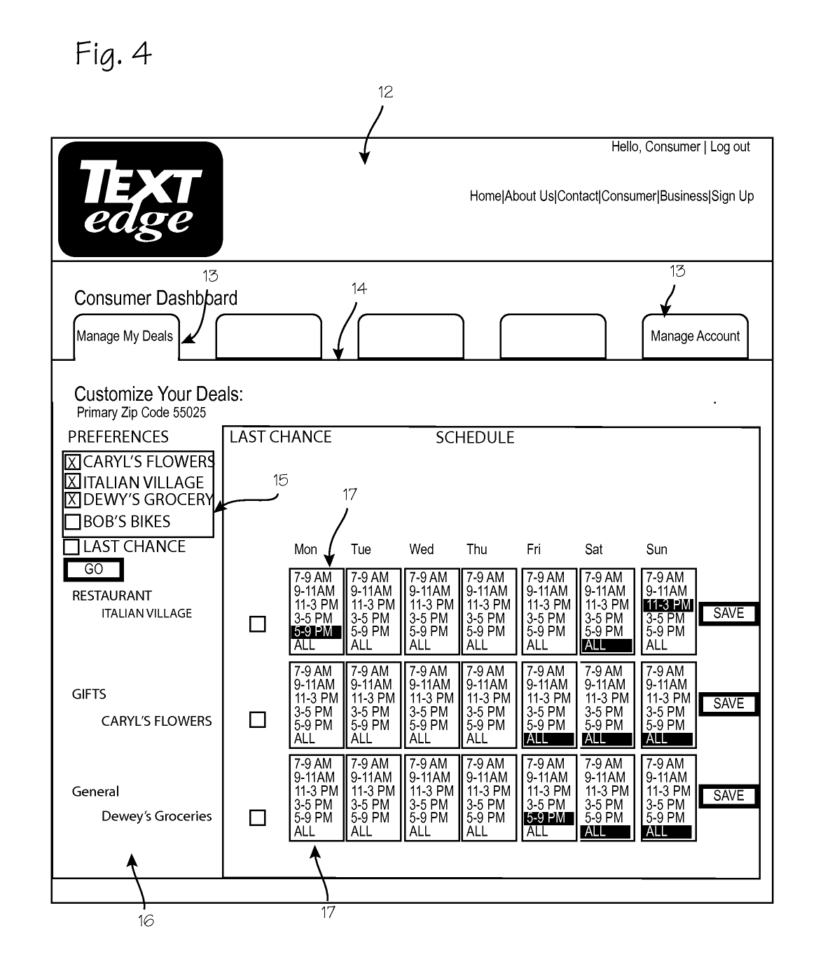

FIG. 4 illustrates an interface presented by the system to consumers, which accepts input from consumers regarding the parameters of coupons which might be of interest to the consumer. The browser window 12 is presented with tabs 13 for selecting view panes for indicating consumer coupon parameters, and for account management. As with the business user, the consumer user has previously entered his location, such that one consumer coupon parameter is entered in the “manage account” view pane or a separate registration window. In the coupon requesting pane 14, which is associate with the tab labeled “Manage My Deals” in this illustration, the computer system displays a list of business, under the label Set Preferences and a schedule. In the manage account view pane, selectable through the tab labeled “Manage Account,” the consumer may enter the more permanent consumer coupon parameters, such his or her location, destination device address for coupons (a telephone number for text messaging, or an e-mail account, or any other communications protocol). In the illustrated coupon requesting pane 14, the consumer may enter additional consumer coupon parameters by clicking on or selecting the various screen elements. For example, the check boxes associated with various participating businesses, in sub-window 15 are checked by the consumer to indicate to the system those preferred businesses for which the consumer would be receptive to coupons. In response to selection of businesses, the computer system generates the preferred business list 16 and schedule selection windows 17. In this view pane, the consumer can indicate time periods for which they would like to receive coupons. The time periods for each business may be set separately, illustrated by the selection of time frames for restaurant coupons for Monday evening, all day Saturday, and Sunday afternoon, and the selection of time frames for coupons from a flower shop all day for Friday, Saturday, and Sunday, for a consumer who is receptive to communication of coupons at those times, but would prefer not to be bothered with numerous unwanted communications at other times. Also in this window, the consumer can indicate whether he is receptive to last chance offers from the listed businesses.

In use, both the business user and the consumer user navigate to their respective dashboard browser windows and enter their respective coupon parameters. The computer system which receives this input matches businesses with consumers who enter parameters indicating interest in those businesses. The matching may be fairly broad, such as correlating consumers interested in a particular type of business, or fairly narrow, such as correlating consumers interested in a specific retailer. For example, the system may allow consumers to express interest in restaurants generally, or express interest in a particular restaurant, and the system may allow consumers to express interest in local theaters or a single specific theater. The computer system will accept input from businesses, through the coupon generating view pane, regarding a coupon to be distributed on behalf of the business user, and distribute coupons to matching consumer users. Thus, after a business user has entered business coupon parameters as illustrated in FIG. 2 or 3 or the like, and instructed the system to send corresponding coupons, the system selects a group of matching receptive consumers and transmits a coupon, or communication containing the coupon, to receptive consumers.

In this manner, businesses can tightly focus the distribution of coupons to a consumer base that is likely to use the coupons, with minimal expense, and minimal possibility of an overwhelming response. Consumers can control the number of solicitations received from participating businesses, and invite solicitations from businesses of interest, and recognize messages from a branded source as invited solicitations rather than mere spam or junkmail. Of particular use to businesses dependent on local consumers, and/or businesses subject to wide variation in operations. In the context of restaurants, for example, a restaurant manager may anticipate a particularly slow time slot, or recognize an opportune tie-in (a Tuesday night, or a live sports broadcast suitable for a sports bar), and through a quick session on the restaurant's dashboard, transmit enough coupons to receptive customers, located close to the restaurant, to encourage a comfortable number of customers to redeem the coupons. Because the restaurant manager limits the number of coupon recipients, the restaurant manager can be confident that the restaurant will not be overwhelmed with a large number of customers that it cannot accommodate. The number of recipients can be increased or decreased for subsequent coupon distributions, based on historical rates of response.

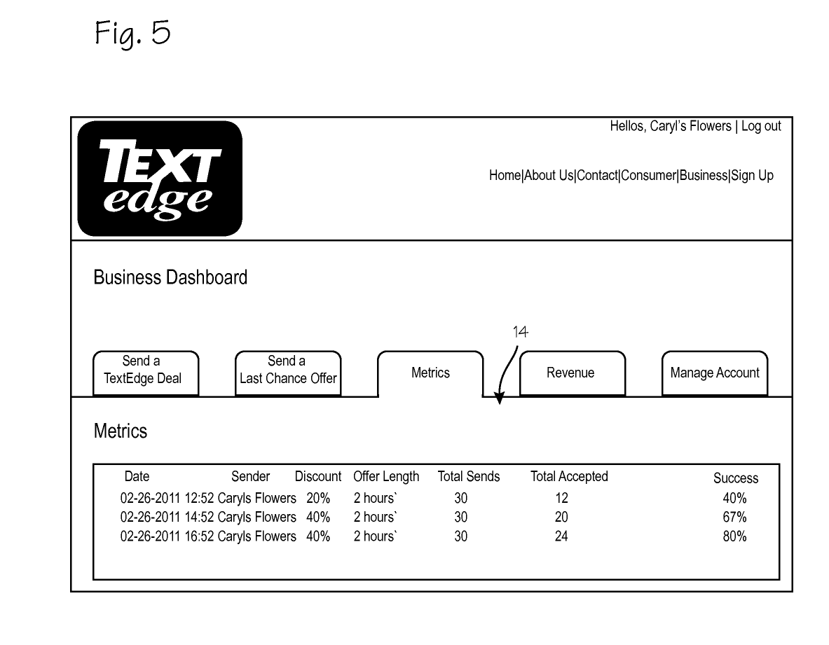

The system is also designed to provide feedback to business regarding the efficacy of the method. FIG. 5 shows a Metrics view pane 18, selected under the “Metrics” tab. In this view pane, the system displays the history of coupons generated by the system on behalf of a business, along with the coupon parameters and the number of coupons accepted. If coupons are prepared with unique identifiers, such as bar codes or alpha-numeric codes, the business user can enter those codes in the system so that the system can track which users redeem coupons. This information can be used as described above to include active consumers in subsequent sub-pools, or to send additional coupons specific to consumers who frequently redeem coupons. Other feedback can also be provided, where feasible, such as tracked revenue associated with the redemption of coupons.

The system can be augmented with additional functions. For example, the system can be programmed to send coupons to different subgroups in a large pool of consumers each time a business user sends a coupon. Some businesses, such as restaurants, have a limited capacity, and would prefer to avoid attracting a number of consumers that exceed their seating capacity, so as to avoid generating the perception that the coupons are very difficult and frustrating to redeem. If a pool of consumer is very large compared to the capacity, this is addressed by the system by first, allowing the business to limit the number of coupons transmitted, and second, by distributing coupons to a different subset of matching receptive consumers for each different coupon transmitted. Thus, if a restaurant is correlated to 1000 local consumers, and chooses in one instance to transmit coupons to 100 of those consumers, the system will send 100 coupons to consumers (chosen on a random basis, or chosen by any arbitrary criterion such as alphabetic order), and thereafter chooses in a second instance to transmit coupons to 100 local consumers, the system will select a different group of consumers from among the 1000 local consumers. The system will subsequently choose different subsets of local consumers. In another mode of operation, the system can track, with feedback from business users, the identity of consumers who redeem coupons, and include those consumers in subsequent groups.

Thus, the method can be described as a method of selling in which promotional offers are transmitted by businesses, or on behalf of businesses to consumers, or a method of distributing coupons and promotional offers. The method is implemented through a network with the necessary network server, microprocessor, memory and computer software stored in the memory and run by said microprocessor. The software includes promotional offer generating algorithm for performing the following steps:
accepting and storing input from a seller regarding products or services to be offered through the network, said input relating to (1) the business field to which the offer pertains (such as restaurant services, pizza delivery, auto repair, entertainment, etc.), or a specific product or service to which the offer pertains, (2) the locale to which the offer is restricted (such as state, county, zip code, etc.), and (3) the time period for which the discount applies (which may be stated by a start time and duration, or an end date), (4) the terms of the promotional offer and (5) the number of consumers to whom the offer is to be transmitted;
accepting and storing input for a plurality of consumers regarding product or service of interest to each consumer, said input relating to (1) the business field in which the consumer is interested, or a specific product or service, (2) the locale in which the consumer would prefer to accept a pertinent offer; (3) the time period in which the consumer prefers to accept a pertinent offer;
comparing input from sellers and input from consumers to determine whether input from sellers and input from sellers match in (1) the business field to which the offer pertains and the business field in which the consumer is interested, and (2) the locale to which the offer is restricted and the locale in which the consumer would prefer to accept a pertinent offer, (3) the time period for which the discount applies and the time period in which the consumer prefers to accept a pertinent offer, and identifying those consumers for whom their input matches the input of sellers;
generating messages (messages may be text messages, e-mail, voice mail, social media posts, etc.) to consumers matched to sellers, said messages containing information pertaining to a promotional offer from the sellers to the identified consumers, and no others.

The necessary computer system is programmed to perform all the necessary method steps, and the programming can be incorporated into readable media, internet servers, through a web application or a promulgated signal. The computer can operate on any platform, at any location. The communications protocols, though expressed in familiar terms of the internet, e-mail and text messaging, may also include any serviceable communication protocol.

While the preferred embodiments of the devices and methods have been described in reference to the environment in which they were developed, they are merely illustrative of the principles of the inventions. The elements of the various embodiments may be incorporated into each of the other species to obtain the benefits of those elements in combination with such other species, and the various beneficial features may be employed in embodiments alone or in combination with each other. Other embodiments and configurations may be devised without departing from the spirit of the inventions and the scope of the appended claims.

We claim:

1. A method of generating and distributing promotional offers by businesses, or on behalf of businesses to consumers, through a network, said network comprising a network server, a microprocessor, a memory and computer software, said computer software being located in said memory and run by said microprocessor, said computer software comprising a promotional offer generating algorithm, wherein said promotional offer generating algorithm, comprises the steps of:
accepting input from a seller regarding products or services to be offered through the network, said input relating to (1) the business field to which the offer pertains, or a specific product or service to which the offer pertains, (2) the locale to which the offer is restricted, and (3) the time period for which the discount applies, (4) the terms of the promotional offer and (5) the number of consumers to whom the offer is to be transmitted;
accepting input for a plurality of consumers regarding product or service of interest to each consumer, said input relating to (1) the business field in which the consumer is interested, or a specific product or service, (2) the locale in which the consumer would prefer to accept a pertinent offer; (3) the time period in which the consumer prefers to accept a pertinent offer;
comparing input from sellers and input from consumers to determine whether input from sellers and input from sellers match in (1) the business field to which the offer pertains and the business field in which the consumer is interested, and (2) the locale to which the offer is restricted and the locale in which the consumer would prefer to accept a pertinent offer, (3) the time period for which the discount applies and the time period in which the consumer prefers to accept a pertinent offer, and identifying those consumers for whom their input matches the input of sellers;
generating messages to consumers matched to sellers, said messages containing information pertaining to a promotional offer from the sellers to the identified consumers, and no others.

2. A system for generating and distributing promotional offers by businesses, or on behalf of businesses to consumers, through a network, said system comprising:
a network server, a microprocessor, a memory and computer software, said computer software being located in said memory and run by said microprocessor,
said computer software comprising a promotional offer generating algorithm, wherein said promotional offer generating algorithm, comprises the steps of:
accepting and storing input from a seller regarding products or services to be offered through the network, said input relating to (1) the business field to which the offer pertains, or a specific product or service to which the offer pertains, (2) the locale to which the offer is restricted, and (3) the time period for which the discount applies, (4) the terms of the promotional offer and (5) the number of consumers to whom the offer is to be transmitted;
accepting and storing input for a plurality of consumers regarding product or service of interest to each consumer, said input relating to (1) the business field in which the consumer is interested, or a specific product or service, (2) the locale in which the consumer would prefer to accept a pertinent offer; (3) the time period in which the consumer prefers to accept a pertinent offer;
comparing input from sellers and input from consumers to determine whether input from sellers and input from sellers match in (1) the business field to which the offer pertains and the business field in which the consumer is interested, and (2) the locale to which the offer is restricted and the locale in which the consumer would prefer to accept a pertinent offer, (3) the time period for which the discount applies and the time period in which the consumer prefers to accept a pertinent offer, and identifying those consumers for whom their input matches the input of sellers;
generating messages to consumers matched to sellers, said messages containing information pertaining to a promotional offer from the sellers to the identified consumers, and no others.
